(19) United States
(12) Patent Application Publication
(10) Pub. No.: US 2006/0181755 A1
(43) Pub. Date: Aug. 17, 2006

(54) Inner drum exposure apparatus

(75) Inventor: Hiroshi Matsuoka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/342,723

(22) Filed: Jan. 31, 2006

(30) Foreign Application Priority Data
Jan. 31, 2005 (JP) 2005-023503

(51) Int. Cl. G02B 26/08

(52) U.S. Cl. 359/211

(57) ABSTRACT

The inner drum exposure apparatus records an image by scanning a recording material held on an arcuate inner peripheral surface of a support with a circularly polarized light beam that is emitted from a light source and modulated in accordance with image information and deflected by a total internal reflection mirror plane of a rotatably driven scanning device such as a spinner. The image is record on the recording material by scanning the recording material with the modulated light beam using the scanning unit. The scanning unit further includes an optical member having on its surface a polarizing beam splitter plane spaced apart from the mirror plane by a predetermined distance. Two beam spots formed on the recording material by two parallel beams obtained by the polarizing beam splitter plane and the mirror plane are combined into a synthetic beam spot in which the beam spots are disposed side by side in a sub scanning direction so as to overlap each other.

The entire contents of literatures cited in this specification are incorporated herein by reference.

### BACKGROUND OF THE INVENTION

The present invention relates to an inner drum exposure apparatus that records an image by scanning a recording material held on the arcuate inner peripheral surface of a support with a light beam that was modulated in accordance with image information and deflected by a total internal reflection mirror plane of a rotatably driven scanning means and, more specifically, to an inner drum exposure apparatus that is capable of consistent halftone recording.

An inner drum exposure apparatus is generally used in which a light beam such as a laser beam is guided to the photosensitive surface of a recording material held on the inner peripheral surface of a cylindrical or drum-shaped support to scan the recording material through exposure (see, for example, JP 10-133132 A) . The recording material on which an image has been recorded through exposure is processed as needed in an automatic developing machine, whereby a latent image formed on the recording material is converted to a visible image.

When the halftone is represented through exposure of a recording material, the inner drum exposure apparatus commonly represents the halftone in a dot shape through AM screening (technique to form a halftone dot image into a gradation image). In AM screening, the minimum unit of a halftone dot image is composed of a large number of dots, for example, 14 (horizontal dots) ×14 (vertical dots), i.e., 196 dots in total. Such a halftone dot image is arranged on a two-dimensional plane to record a gradation image. However, when AM screening is used to represent the halftone, moiré fringes or tone jump may often occur.

FM screening is also available as a technique to form a halftone dot image into a gradation image. FM screening represents gradations in a recorded image depending on how densely dots of indefinite shape having no regularity are packed. The gradations are represented by arranging an image composed of a relatively small number of dots, e.g., 2×2 dots, i.e., 4 dots in total, on a two-dimensional plane in a dispersed manner. FM screening is advantageous in that moiré fringes can be suppressed based on its principle.

For this reason, also in an inner drum exposure apparatus capable of achieving high productivity, it has been desired to represent the halftone with small dots through FM screening.

However, in a usual inner drum exposure apparatus configured so that a light beam emitted from a laser light source of a single lateral mode is imaged on the scanning surface of a recording material to form an image, a beam spot formed by the light beam on the scanning surface (recording surface) of the recording material has a Gaussian intensity distribution. When pixel recording is performed by exposing the recording material with the beam spot having such a Gaussian intensity distribution, the apparatus is usually designed such that the half-width of the beam spot can be equal to or larger than the pixel size to prevent gaps from being formed between scanning lines.

In the case of an image recorded by exposing through FM screening with a light beam having a spot whose edge portion is relatively gentle, the size of recording pixels is changed due to fluctuations in optical power, the degree to which development is effected by an automatic developing machine or other factor, which may abruptly change the ratio in a halftone dot image (halftone dot area ratio), leading to large gradation changes. The above design is done to prevent such a situation.

However, the above measure does not solve the problem that it is difficult to represent the halftone with small dots by using FM screening in an inner drum exposure apparatus, because the beam spot has a Gaussian intensity distribution.

### SUMMARY OF THE INVENTION

The present invention has been made under these circumstances and it is an object of the present invention to solve the conventional problems by providing an inner drum exposure apparatus capable of consistent halftone recording.

In order to achieve the above object, the present invention provides an inner drum exposure apparatus, comprising:

a support having an arcuate inner peripheral surface on which a recording material on which an image is record is held;

a light source which emits circularly polarized light as a light beam;

modulating means which modulates in accordance with image information of the image the light beam emitted from the light source; and

scanning means which is rotatably driven, has a total internal reflection mirror plane, and scans the recording material held on the arcuate inner peripheral surface of the support with the light beam that is modulated in accordance with the image information by the modulating means and deflected by the total internal reflection mirror plane of the rotatably driven scanning means, wherein

the image is record on the recording material by scanning the recording material with the modulated light beam using the scanning means,

the scanning means further comprises an optical member having on its surface a polarizing beam splitter plane which is spaced apart from the total internal reflection mirror plane by a predetermined distance, and

two beam spots respectively formed on the recording material by two parallel beams that were obtained by the polarizing beam splitter plane and the total internal reflection mirror plane are combined into a synthetic beam spot in which the two beam spots are disposed side by side in a sub scanning direction so as to overlap each other.

The predetermined distance between the polarizing beam splitter plane and the total internal reflection mirror plane preferably approximates to a half-width of the light beam.

The polarizing beam splitter plane preferably has optical properties according to which a P-polarized component of the light beam is substantially transmitted through the polarizing beam splitter plane but an S-polarized component of the light beam is substantially reflected therefrom.

It is preferable that the optical member be a thin film formed on the total internal reflection mirror plane by a thin film forming technique, and that the polarizing beam splitter plane be a surface of the thin film formed on the total internal reflection mirror plane by the thin film forming technique.

Preferably, the optical member includes a transparent support member formed on the total internal reflection mirror plane and a thin film formed on the transparent support member by a thin film forming technique, and the polarizing beam splitter plane is a surface of the thin film formed by the thin film forming technique on the transparent support member, which in turn is formed on the total internal reflection mirror plane.

It is preferred that the scanning means further include a support block having the total internal reflection mirror plane formed thereon and a balance adjusting member which is provided on the polarizing beam splitter plane, is substantially identical in weight with the support block, and is made of a transparent material.

An anti-reflection layer is preferably formed on the polarizing beam splitter plane.

The present invention has a marked effect of realizing an inner drum exposure apparatus capable of consistent halftone recording.

More specifically, according to the present invention having a relatively simple configuration, one light beam can be split into two light beam components and the light beam components form on the scanning surface (recording surface of the recording material) two beam spots, respectively, which are disposed side by side and combined into a substantially rectangular shape. The leading edge of the light intensity distribution can be made steep in the edge portion of the spot. Thus, exposure using such beam spots produces an effect of consistent halftone recording.

### BRIEF DESCRIPTION OF THE DRAWINGS

In the accompanying drawings:

FIG. 1 is a perspective view schematically showing the configuration of an inner drum exposure apparatus according to an embodiment of the present invention;

FIG. 2 is a detail view showing the configuration of a spinner mirror unit in the inner drum exposure apparatus shown in FIG. 1;

FIG. 3 shows a beam spot formed in the inner drum exposure apparatus shown in FIG. 1 by splitting a light beam into an S-polarized ized component s and a P-polarized component p and shifting the P-polarized component p so that they are disposed side by side and are parallel to each other;

Fig,. 4 shows a beam spot formed by a conventional technique; and

FIG. 5 is a detail view showing the configuration of a spinner mirror unit in an inner drum exposure apparatus according to another embodiment.

### DESCRIPTION OF THE PREFERRED EMBODIMENTS

In the following, the present invention will be described in detail with reference to the preferred embodiments shown in the attached drawings.

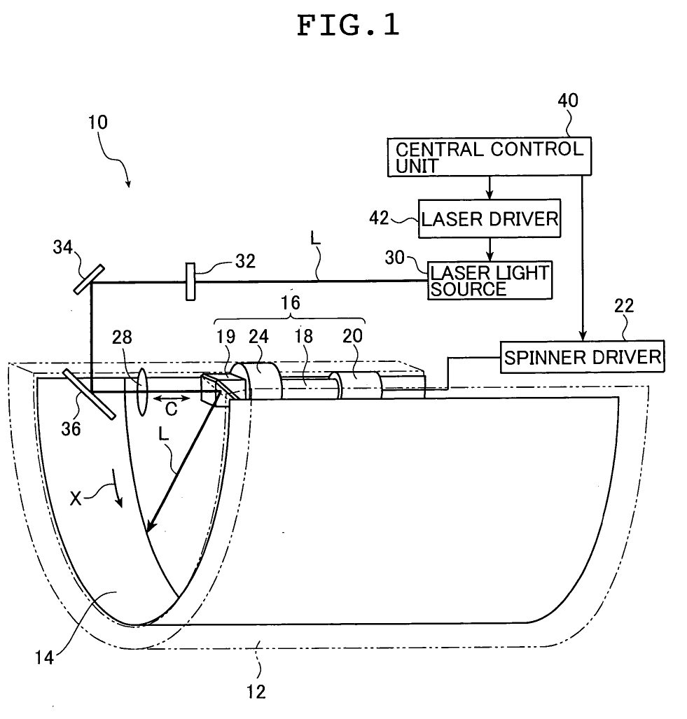

FIG. 1 is a perspective view schematically showing the configuration of an inner drum exposure apparatus according to an embodiment of the present invention. The characteristic feature of the inner drum exposure apparatus according to the embodiment under consideration is that, in order to allow the halftone to be represented with small dots using FM screening, two beam spots formed on the recording material by two parallel beam components, respectively, are combined into a synthetic beam spot in which the two beam spots are disposed side by side in a sub scanning direction (in the direction in which a spinner mirror unit 16 to be described later performs scanning) so as to overlap each other.

As shown in FIG. 1, an inner drum exposure apparatus 10 according to this embodiment includes as its base a support 12 having a shape constituting part of the inner peripheral surface of a cylinder. A recording material 14 (photopolymer plate or an ordinary PS plate) is supported on the inner peripheral surface of the support 12.

A supply/discharge unit (not shown) in the inner drum exposure apparatus 10 supplies the recording material 14 on which recording is not performed yet, to the support 12 so that the recording material 14 is surely brought into intimate contact with the inner peripheral surface of the support 12, subjects the supplied recording material 14 to exposure, and discharges the exposed recording material 14 from the support 12 to the exterior.

The spinner mirror unit 16 serving as a scanning means is provided at the central position of the arc-shaped support 12 in the inner drum exposure apparatus 10 of this embodiment. The spinner mirror unit 16 is configured such that a drive source, that is, a motor 20 is capable of rotating a cylindrical rotary shaft 18 around its central axis (which coincides with the central axis of the arc-shaped support 12).

A cube prism 19 having a total internal reflection mirror plane 19A to be described later and a polarizing beam splitter plane 19B spaced apart from the total internal reflection mirror plane 19A by a predetermined distance is provided at the forward end of the rotary shaft 18 of the spinner mirror unit 16 so that the planes 19A and 19B each form an angle of 45 degrees with respect to the rotary shaft 18.

The spinner mirror unit 16 described above is moved for scanning at a constant speed in the axial directions (indicated by a double-headed arrow C in FIG. 1) on the central axis of the arc-shaped support 12 by a sub scanning moving means (not shown). In the spinner mirror unit 16, a spinner driver 22 controls the rotation speed of the motor 20 and the sub scanning moving means controls the movement of the unit 16 in the sub scanning direction.

The characteristic operation of the inner drum exposure apparatus 10 of this embodiment is as follows: A beam is split (into two components in this embodiment) and the split beam is used to perform main scanning in the direction indicated by an arrow X in FIG. 1 on the recording surface of the recording material 14 disposed (set) on the inner peripheral surface of the support 12.

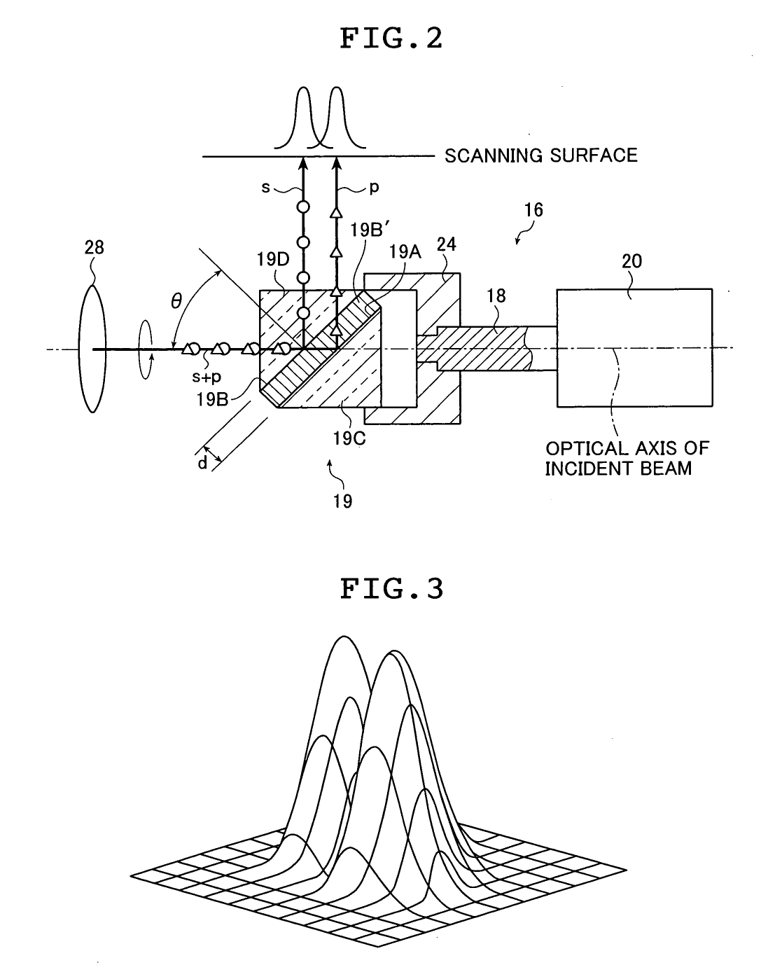

The cube prism 19 that includes the total internal reflection mirror plane 19A and the polarizing beam splitter plane 19B is firmly held by a holder 24 (see FIG. 2) which is engaged with the rotary shaft 18 so as to integrally rotate with the rotary shaft 18 of the spinner mirror unit 16.

The cube prism 19 that includes the total internal reflection mirror plane 19A and the polarizing beam splitter plane 19B is disposed at the rear of a condenser lens 28 on the light source side (on the side farther from a light source). A dielectric film 19B′ (its thickness is shown in an exaggerated manner in FIG. 2 for purposes of illustration) is formed on the total internal reflection mirror plane 19A so that the total internal reflection mirror plane 19A is spaced apart from the polarizing beam splitter plane 19B by a predetermined distance d (this distance depends on the distance between the two components into which the beam is split and corresponds to the thickness d of the dielectric film 19B′). The dielectric film 19B′ constitutes the optical member of the present invention whose surface is the polarizing beam splitter plane 19B.

FIG. 2 shows a specific structure of the cube prism 19. The distance between the two components into which the beam is split and which are disposed side by side is about 5 μm. Since the angle of inclination of the total internal reflection mirror plane 19A with respect to the optical axis is 45 degrees, the thickness d of the dielectric film 19B′ is obtained as follows:
5/√2≃3.54.

The cube prism 19 includes an optical glass block 19C that has the total internal reflection mirror plane 19A inclined at 45 degrees for obtaining the angle of reflection of 45 degrees. In order to adjust the weight balance with the glass block 19C, a glass block 19D formed from optical glass is secured in front (on the side closer to the light source) of the polarizing beam splitter plane 19B of the cube prism 19.

The weight balance of the cube prism 19 as a whole during the rotation is thus ensured, which allows the spinner mirror unit 16 of the inner drum exposure apparatus 10 to be stably rotated at a high speed.

The polarizing beam splitter plane 19B has a function of only reflecting the S-polarized component s of a circularly polarized light beam that was incident on the cube prism 19, and transmitting the P-polarized component p therethrough as it is. The P-polarized component p having been transmitted through the polarizing beam splitter plane 19B is reflected from the total internal reflection mirror plane 19A.

Based on the difference in the reflection property of the two planes and the distance between the total internal reflection mirror plane 19A and the polarizing beam splitter plane 19B (represented by the formula: 5/√2) one circularly polarized light beam having entered the cube prism 19 is formed into two deformed beams spaced apart from each other by about 5 μm (beams disposed side by side).

The two beams (composed of the S-polarized component s and the P-polarized component p, respectively) are obtained by splitting the circularly polarized light beam; and hence are substantially identical in light intensity (quantity of light). As will be described later, when disposed in close proximity to each other, they are formed (combined) into a synthetic light beam that has a substantially rectangular sectional shape elongated in the sub scanning direction and is substantially uniform in light intensity. The synthetic light beam forms on the scanning surface (recording surface) of the recording material 14 a beam spot having a substantially rectangular shape elongated in the sub scanning direction (substantially rectangular beam spot).

The technique for forming thin films made of various fluorides as disclosed in JP 10-8252 A and the technique for forming thin films made of quartz glass as disclosed in JP 05-88034 A are available for the material and method for forming the thin film to be used to dispose the total internal reflection mirror plane 19A and the polarizing beam splitter plane 19B in proximity to each other.

When one light beam is split into the S-polarized component s and the P-polarized component p having substantially identical light intensities (quantities of light), and one of the components is shifted with respect to the other so that both the components can be parallel to each other and form beam spots side by side on the scanning surface (recording surface of the recording material 14), the state as shown in FIG. 3 is obtained in which the two beam components each having a light intensity with a Gaussian distribution having, for example, a half-width of 5 μm are disposed side by side at a distance of about 5 μm. The beam spots on the scanning surface have a shape closer to a rectangular shape in the sub scanning direction and have a sharp light intensity distribution shape (leading edge) in the main scanning direction (the direction in which scanning is performed by the spinner mirror unit 16; direction as indicated by the arrow X in FIG. 1).

FIG. 4 shows the shape of a conventional beam spot with a Gaussian distribution having a half-width of 8.8 μm (1/e² width: 15 μm). The comparison between the above case and the case shown in FIG. 4 in which the conventional beam spot formed by the light beam having a light intensity with a Gaussian distribution has a circular cross section, is not elongated in the sub scanning direction and has a gently flaring shape in the light intensity distribution (leading edge) clearly shows the difference in the effect achieved.

Since the inner drum exposure apparatus 10 of the embodiment under consideration is configured such that the spinner mirror unit 16 performs beam splitting and main scanning on the recording surface of the recording material 14 as shown in FIG. 2, the spinner mirror unit 16 is provided with a light source-side optical system for emitting a circularly polarized light beam.

As shown in FIG. 1, the light source-side optical system includes a semiconductor laser light source (LD) 30 for outputting a substantially linearly polarized laser beam L, and a condensing optical system for condensing the laser beam L emitted from the semiconductor laser light source 30 on the exposure surface of the recording material 14. As the semiconductor laser light source 30, it is possible to use a single lateral mode semiconductor laser having an intensity distribution in which the central light intensity is high, and the light intensity gradually decreases as the distance from the center increases.

Starting from the semiconductor laser light source 30, the light source-side optical system includes, for example, a quarter-wave plate 32, reflecting mirrors 34, 36 and the condenser lens 28 arranged in this order.

The quarter-wave plate 32 has a function of converting the substantially linearly polarized laser beam L emitted from the semiconductor laser light source 30 into the circularly polarized laser beam by transmitting it through the quarter-wave plate 32.

The circularly polarized laser beam L obtained in the quarter-wave plate 32 is condensed by the condenser lens 28 and then transmitted through the cube prism 19 having the total internal reflection mirror plane 19A and the polarizing beam splitter plane 19B. The circularly polarized laser beam L is split into two beam components having substantially identical light intensities (quantities of light). One of the beam components is shifted with respect to the other to obtain a beam having the beam components which are disposed side by side in the sub scanning direction and are parallel to each other.

The two beam components having substantially identical light intensities (quantities of light) are emitted from the cube prism 19, are condensed/impinge on the exposure surface (scanning surface) of the recording material 14 set on the inner peripheral surface of the support 12 of the inner drum exposure apparatus 10 to form at the condensation point a beam spot having a substantially rectangular shape in the sub scanning direction, and then are subjected to exposure.

In the inner drum exposure apparatus 10 of this embodiment, an image is recorded on the recording material 14 while the spinner mirror unit 16 and the semiconductor laser light source 30 are controlled by a central control unit 40 as shown in FIG. 1. In the inner drum exposure apparatus 10, image information for exposure is input from an input unit (not shown), and an exposure start command is transmitted to the central control unit 40. Then, the central control unit 40 transmits an image signal to a laser driver 42 based on the image information.

The laser driver 42 controls the drive of the semiconductor laser light source 30 so that the laser beam L modulated based on the image signal is emitted to be incident on the spinner mirror unit 16 through the light source-side optical system. At the same time, the central control unit 40 controls the drive of the motor 20 so that the recording material 14 set on the support 12 is exposed for scanning in the main scanning direction with the light incident from the light source-side optical system on the spinner mirror unit 16 (cube prism 19). The central control unit 40 also transmits a control signal to the spinner driver 22.

Upon receipt of the control signal, the spinner driver 22 controls the sub scanning moving means (not shown) to move the spinner mirror unit 16 at a constant speed for scanning. In this way, a two-dimensional image is recorded on the entire recording surface of the recording material 14 by moving the spinner mirror unit 16 in the sub scanning direction while exposure for scanning in the main scanning direction is performed with the spinner mirror unit 16.

Next, the operation of the inner drum exposure apparatus 10 of this embodiment will be described in detail.

In the inner drum exposure apparatus 10 of this embodiment, the semiconductor laser light source 30 controlled by the central control unit 40 and the laser driver 42 outputs the laser beam L. modulated in accordance with the image information. The output laser beam L is incident on the quarter-wave plate 32, where the substantially linearly polarized laser beam L is converted into the circularly polarized laser beam. The circularly polarized laser beam is incident on the spinner mirror unit 16 (cube prism 19) after having been reflected from the reflecting mirrors 34, 36 and condensed by the condenser lens 28.

The cube prism 19 splits the circularly polarized laser beam L into the S-polarized component s and the P-polarized component p. As described above, the S-polarized component s and the P-polarized component p obtained as a result of beam splitting are set to be substantially identical in light intensity.

The S-polarized component s and the P-polarized component p with their light intensities adjusted as obtained in the cube prism 19 through beam splitting in the sub scanning direction are then condensed on the recording material 14 so that these components form at the condensing point thereof (on the scanning surface thereof) a synthetic beam spot having a substantially rectangular distribution in the sub scanning direction. That is, the inner drum exposure apparatus 10 always keeps the state in which the synthetic beam spot formed on the scanning surface as a result of beam splitting has a substantially rectangular distribution and is elongated in the sub scanning direction, and the leading edge of the light intensity in the edge portion is steep.

In other words, since exposure is performed while always keeping the state in which the longitudinal direction of the beam spot having a substantially rectangular distribution on the scanning surface conforms to the sub scanning direction, an image recorded through the FM screening described above has no change in the perimeter of each recording pixel due to any fluctuations in optical power, and abrupt change of the ratio in a halftone dot image (halftone dot area ratio) is also prevented, which enables consistent halftone recording when the FM screening is used.

Next, an inner drum exposure apparatus according to another embodiment of the present invention will be described.

As in the above-described embodiment, the inner drum exposure apparatus of this embodiment is also characterized in that, in order to allow the halftone to be represented with small dots using FM screening, two beam spots formed on the recording material by two parallel beam components, respectively, are combined into a synthetic beam spot in which the two beam spots are disposed side by side in the sub scanning direction so as to overlap each other.

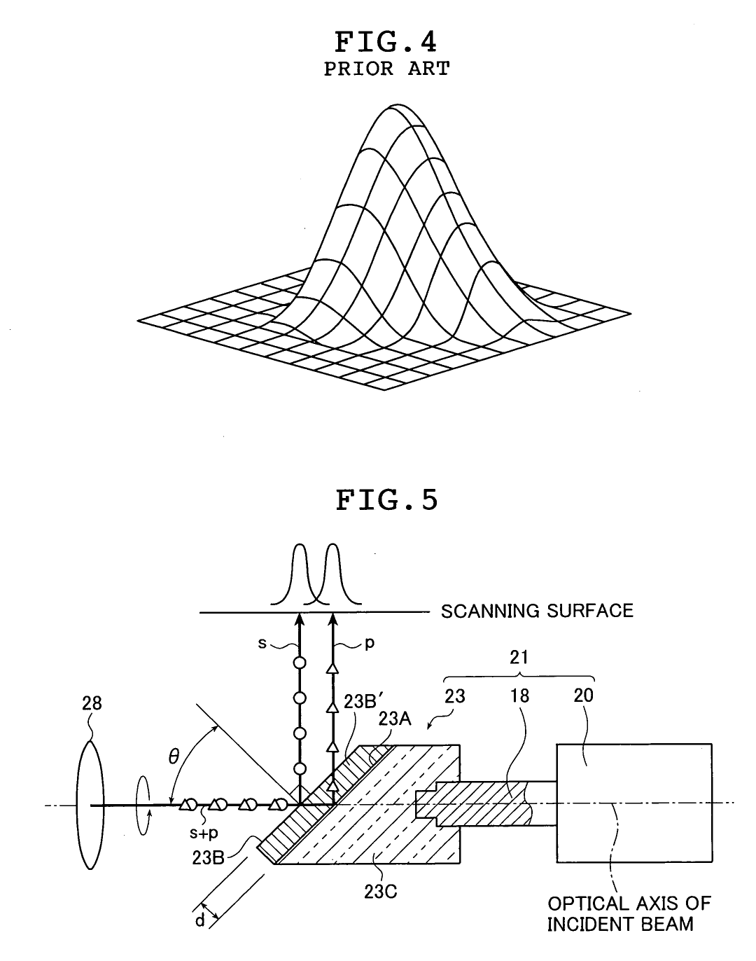

The inner drum exposure apparatus of this embodiment differs from the inner drum exposure apparatus 10 of the embodiment shown in FIG. 1 in that the spinner mirror unit 16 (see FIG. 2) of the inner drum exposure apparatus 10 in the embodiment shown in FIG. 1 is replaced by a spinner mirror unit 21 as shown in FIG. 5.

The spinner mirror unit 16 shown in FIG. 2 includes the cube prism 19 that has a function of only reflecting the S-polarized component s of the circularly polarized incident light beam from the polarizing beam splitter plane 19B and transmitting the P-polarized component p therethrough as it is, whereas the spinner mirror unit 21 shown in FIG. 5 includes a cylindrical mirror 23 secured to the rotary shaft 18 of the spinner mirror unit 21.

The cylindrical mirror 23 includes a metal body 23C which has a heavier weight than the cube prism 19, a total internal reflection mirror plane 23A formed on a surface inclined at 45 degrees of the metal body 23C, a dielectric film 23B′ having the predetermined thickness d and formed on the total internal reflection mirror plane 23A by a thin film forming technique, and a polarizing beam splitter plane 23B formed on a surface of the dielectric film 23B′. The thickness d of the dielectric film 23B′ corresponds to the predetermined distance d by which the total internal reflection mirror plane 23A is spaced apart from the polarizing beam splitter plane 23B. The total internal reflection mirror plane 23A, the dielectric film 23B′ and the polarizing beam splitter plane 23B have the functions corresponding to the total internal reflection mirror plane 19A, the dielectric film 19B′ and the polarizing beam splitter plane 19B, respectively.

In the cube prism 19 of the previously described embodiment, the glass block 19D formed from optical glass is provided on the polarizing beam splitter plane 19B to adjust the weight balance with the glass block 19C. On the other hand, the cylindrical mirror 23 of this embodiment does not use such a member for the weight balance. Instead, the weight of the cylindrical mirror 23 itself is made larger than that of the cube prism 19 to reduce the difference in weight between both the ends of the inclined surface as a whole.

The operation of the inner drum exposure apparatus using the cylindrical mirror 23 according to this embodiment is substantially the same as that of the inner drum exposure apparatus 10 according to the previously described embodiment, so detailed description will be omitted.

In order to show whether the light beam before or after the reflection from or transmission through the polarizing beam splitter plane 19B of the cube prism 19 or the polarizing beam splitter plane 23B of the cylindrical mirror 23 has the S-polarized component s and/or the P-polarized component p, the optical axes are marked with ◯ and Δ in FIGS. 2 and 5.

In the embodiments shown in FIGS. 2 and 5, the total internal reflection mirror planes 19A and 23A of the cube prism 19 and the cylindrical mirror 23 are inclined at 45 degrees, respectively. However, the angle of inclination is not limited to 45 degrees but may be generally set as θ (see FIGS. 2 and 5). In this case, the thickness d of the dielectric film 19B′ or 23B′ for adjusting the distance between the two beam components disposed side by side to about 5 μm is represented by the formula: d=5×cosθ(μm).

The embodiment shown in FIG. 5 refers to the case in which the polarizing beam splitter plane 23B is obtained by forming the dielectric film 23B′ serving as the optical member of the present invention on the total internal reflection mirror plane 23A of the cylindrical mirror 23 by a thin film forming technique. However, a transparent optical glass layer may be first formed before a thinner dielectric film is formed thereon so that the optical member of the present invention may be of a two-layer structure which includes the optical glass layer and the thinner dielectric film forming the polarizing beam splitter plane 23B.

An anti-reflection film (AR layer) may be formed on the polarizing beam splitter plane 23B formed from the dielectric film in order to prevent any unnecessary reflection from the polarizing beam splitter plane 23B.

The above-described embodiments are only shown by way of example, and the present invention is not restricted thereto. It goes without saying that various modifications and improvements are possible without departing from the gist of the present invention.

The optical glass block 19C having the total internal reflection mirror plane A inclined at 45 degrees for obtaining the angle of reflection of 45 degrees is disposed in the cube prism 19 shown in the firstly described embodiment, but the block may be formed from other materials such as a metal (e.g., beryllium). In the latter case, the glass block 19D provided in front of the polarizing beam splitter plane 19B of the cube prism 19 has preferably a size (or weight) corresponding to the material used such as a metal (or its density).

In the respective embodiments described above, the prism (cube prism 19 or the cylindrical mirror 23) that forms the total internal reflection mirror plane and the polarizing beam splitter plane is in the shape of a quadrangular prism or a cylinder. However, any other shape such as a polygonal shape may of course be adopted taking into account the balance during rotation.

What is claimed is:

1. An inner drum exposure apparatus, comprising:
a support having an arcuate inner peripheral surface on which a recording material on which an image is record is held;
a light source which emits circularly polarized light as a light beam;
modulating means which modulates in accordance with image information of said image said light beam emitted from said light source; and
scanning means which is rotatably driven, has a total internal reflection mirror plane, and scans said recording material held on said arcuate inner peripheral surface of said support with said light beam that is modulated in accordance with said image information by said modulating means and deflected by said total internal reflection mirror plane of said rotatably driven scanning means, wherein
said image is record on said recording material by scanning said recording material with said modulated light beam using said scanning means,
said scanning means further comprises an optical member having on its surface a polarizing beam splitter plane which is spaced apart from said total internal reflection mirror plane by a predetermined distance, and
two beam spots respectively formed on said recording material by two parallel beams that were obtained by said polarizing beam splitter plane and said total internal reflection mirror plane are combined into a synthetic beam spot in which said two beam spots are disposed side by side in a sub scanning direction so as to overlap each other.

2. The inner drum exposure apparatus according to claim 1, wherein said predetermined distance between said polarizing beam splitter plane and said total internal reflection mirror plane approximates to a half-width of said light beam.

3. The inner drum exposure apparatus according to claim 1, wherein said polarizing beam splitter plane has optical properties according to which a P-polarized component of said light beam is substantially transmitted through said polarizing beam splitter plane but an S-polarized component of said light beam is substantially reflected therefrom.

4. The inner drum exposure apparatus according to claim 1, wherein said optical member is a thin film formed on said total internal reflection mirror plane by a thin film forming technique, said polarizing beam splitter plane is a surface of said thin film formed on said total internal reflection mirror plane by said thin film forming technique.

5. The inner drum exposure apparatus according to claim 1, wherein said optical member includes a transparent support member formed on said total internal reflection mirror plane and a thin film formed on said transparent support member by a thin film forming technique, and said polarizing beam splitter plane is a surface of said thin film formed by said thin film forming technique on said transparent support member, which in turn is formed on said total internal reflection mirror plane.

6. The inner drum exposure apparatus according to claim 1, wherein said scanning means further includes a support block having said total internal reflection mirror plane formed thereon and a balance adjusting member which is provided on said polarizing beam splitter plane, is substantially identical in weight with said support block, and is made of a transparent material.

7. The inner drum exposure apparatus according to claim 1, wherein an anti-reflection layer is formed on said polarizing beam splitter plane.
